(19) United States
(12) Patent Application Publication
(10) Pub. No.: US 2009/0197651 A1
(43) Pub. Date: Aug. 6, 2009

(54) WIRELESS COMMUNICATION TERMINAL AND BATTERY CAPACITANCE MEASURING METHOD

(75) Inventor: POU-YING CHEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/237,202

(22) Filed: Sep. 24, 2008

(30) Foreign Application Priority Data
Jan. 31, 2008 (CN) 200810300279.X

(51) Int. Cl. H02J 7/04; H04M 1/02

(52) U.S. Cl. 455/573; 320/162

(57) ABSTRACT

A wireless communication terminal includes a battery module, a storage module, a voltage detection module, and a central processing module. The battery module provides power to the wireless communication terminal and can be charged by an external charger. The storage module stores a voltage offset and a voltage-capacitance relation between voltages and battery capacitance of the battery module. The voltage detection module detects a voltage of the battery module. The central processing module calculates an actual voltage of the battery module according to the detected voltage and the voltage offset in the storage module. Subsequently, the central processing module obtains actual battery capacitance of the battery module according to the actual voltage of the battery module and the voltage-capacitance relation in the storage module.

### BACKGROUND

1. Field of the Invention

The invention relates to wireless communication terminals and, particularly, to a wireless communication terminal and battery capacitance measuring method thereof.

2. Description of Related Art

Wireless communication terminals, such as mobile phones and portable computers, have become increasingly popular and contain a growing number of functionalities. However, in order to incorporate numerous functions within communication terminals, a significantly increased amount of power is needed. Therefore, battery management is very important in the design of wireless communication terminals.

It is very important to measure battery capacitance for wireless communication terminals. When the battery capacitance of wireless communication terminals is low, the wireless communication terminals will manage and limit the consumption of power from certain applications to avoid further loss of power. In addition, wireless communication terminals continuously display their current battery capacitance level, allowing users to charge the battery accordingly.

However, due to interferences from internal electric circuits, along with imprecise battery capacitance measuring circuits within wireless communication terminals, the measurement of battery capacitance may be inaccurate. As a result, users may be misled into excessively charging their wireless communication terminals, thereby reducing the longevity of the wireless communication terminals.

Therefore, a wireless communication terminal with precise battery capacitance measuring circuits is desired to overcome the above-described shortcomings.

### SUMMARY

A wireless communication terminal includes a battery module, a storage module, a voltage detection module, and a central processing module. The battery module is used for providing power to the wireless communication terminal and is charged by an external charger. The storage module is used for storing a voltage offset and a voltage-capacitance relation. The voltage detection module is used for detecting a voltage of the battery module. The central processing module is used for calculating an actual voltage of the battery module according to the detected voltage and the voltage offset in the storage module. Additionally, the central processing module obtains the actual battery capacitance of the battery module according to the actual voltage of the battery module and the voltage-capacitance relation in the storage module.

Other advantages and novel features will become more apparent from the following detailed description when taken in conjunction with the accompanying drawings.

### BRIEF DESCRIPTION OF THE DRAWINGS

FIG. 1 is a schematic diagram of an embodiment of a wireless communication terminal.

FIG. 2 is a flowchart illustrating a first embodiment of a battery capacitance measuring method.

FIG. 3 is a flowchart illustrating a second embodiment of a battery capacitance measuring method.

### DETAILED DESCRIPTION OF THE EMBODIMENTS

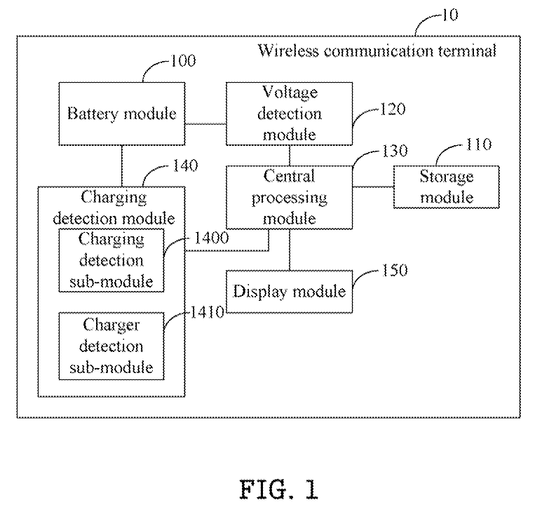

FIG. 1 is a schematic diagram of an embodiment of a wireless communication terminal 10. In one embodiment, the wireless communication terminal 10 includes a battery module 100, a storage module 110, a voltage detection module 120, and a central processing module 130. The battery module 100 is configured for providing power to the wireless communication terminal 10 and may be charged by an external charger (not shown). The storage module 110 is configured for storing a voltage offset of the battery module 100 and a voltage-capacitance relation between voltages and battery capacitance of the battery module 100. In one embodiment, the storage module 110 stores a graph showing a curve of the voltage-capacitance relation before the wireless communication terminal 10 is shipped. The voltage offset is calculated and stored when the wireless communication terminal 10 has been fully charged for the first time, and the calculating method is described below. The voltage detection module 120 is connected to the battery module 100 and is configured for detecting a voltage of the battery module 100 and sending the detected voltage to the central processing module 130. In practical applications, there is an offset between the detected voltage and an actual voltage of the battery module 100.

The central processing module 130 is connected to the voltage detection module 120 and is configured for calculating the actual voltage of the battery module 100 according to the detected voltage sent by the voltage detection module 120 and the voltage offset in the storage module 110, and obtaining actual battery capacitance of the battery module 100 according to the voltage-capacitance relation in the storage module 110.

In one embodiment, the wireless communication terminal 10 further includes a charging detection module 140 connected to the battery module and the central processing module 130 and configured for detecting if the battery module 100 has been fully charged and if the external charger has been removed. If the charging detection module 140 detects that the battery module 100 has been fully charged for the first time and the external charger has been removed, the charging detection module 140 generates a triggering signal and sends the triggering signal to the central processing module 130. If the battery module 100 is not fully charged and the external charger has been removed, the charging detection module 140 does not act. The voltage detection module 120 includes an offset calculating flag including an enable status and a disable status. The enable status represents that the battery module 100 has been fully charged for the first time and the external charger has been removed, and the voltage offset of the battery module 100 is calculated. The disable status represents that the voltage offset of the battery module 100 has been determined. In one embodiment, for exemplary purposes, the enable status is represented by “0”, while the disable status is represented by “1”. It may be appreciated that the enable status and the disable status may be represented by other numbers or letters.

The central processing module 130 receives the triggering signal from the charging detection module 140 and sets the offset calculating flag to the enable status. When the voltage detection module 120 detects that the offset calculating flag is in the enable status, the voltage detection module 120 detects an initial voltage of the battery module 100 and sends the initial voltage to the central processing module 130. The central processing module 130 receives the initial voltage, calculates the voltage offset according to the initial voltage and the voltage-capacitance relation and stores the voltage offset in the storage module 110. The central processing module 130 also sets the offset calculating flag of the voltage detection module 120 to the disable status.

In one embodiment, the initial voltage is detected by the voltage detection module 120 when the battery module 100 has been fully charged for the first time and the external charger has just been removed. At this time, the battery capacitance of the battery module 100 may be 100% charged. The central processing module 130 searches for the voltage-capacitance relation to retrieve the actual voltage corresponding to 100% battery capacitance, and calculates the voltage offset by the initial voltage corresponding to the 100% battery capacitance minus the actual voltage corresponding to 100% battery capacitance.

In one embodiment, the charging detection module 140 includes a charging detection sub-module 1400 and a charger detection sub-module 1410. The charging detection sub-module 1400 is configured for detecting if the battery module 100 has been fully charged. In one embodiment, the charging detection sub-module 1400 determines the battery module 100 has been fully charged when it detects that the voltage of the battery module 100 has reached a highest value. The charger detection sub-module 1410 is configured for detecting if the external charger has been removed.

In one embodiment, the wireless communication terminal 10 further includes a display module 150 connected to the central processing module 130 and configured for displaying the actual battery capacitance of the battery module 100. In one embodiment, the wireless communication terminal 10 may be a mobile phone or a portable computer.

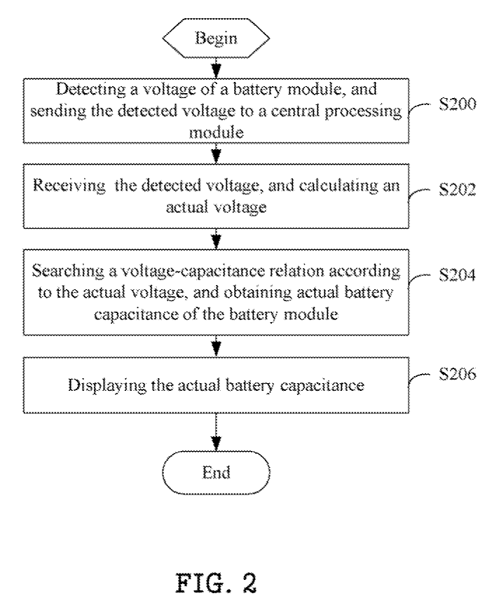

FIG. 2 is a flowchart illustrating a first embodiment of a battery capacitance measuring method of the wireless communication terminal 10. Depending on the embodiment, certain of the blocks described below may be removed, others may be added, and the sequence of blocks may be altered. In a block S200, the voltage detection module 120 detects the voltage of the battery module 100 and sends the detected voltage to the central processing module 130. Continuing to a block S202, the central processing module 130 receives the detected voltage and calculates the actual voltage according to the voltage offset in the storage module 110 and the detected voltage. Moving to a block S204, the central processing module 130 searches for the voltage-capacitance relation according to the actual voltage and obtains the actual battery capacitance of the battery module 100. Continuing to a block S206, the central processing module 130 sends the actual battery capacitance to the display module 150, and the display module 150 displays the actual battery capacitance.

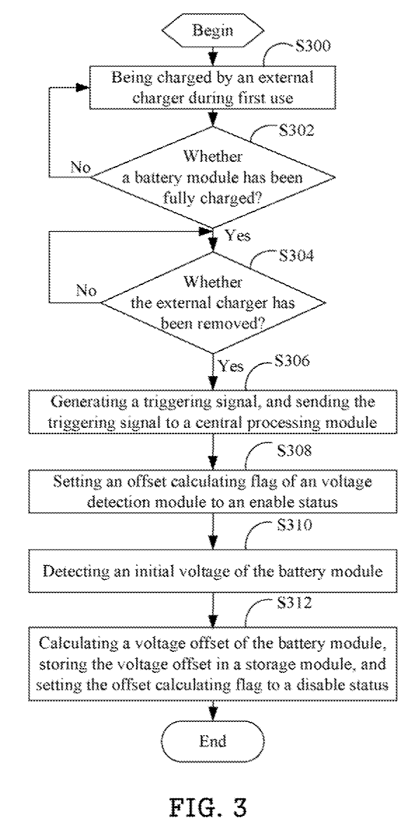

FIG. 3 is a flowchart illustrating a second embodiment of a voltage offset calculating method of the battery capacitance measuring method. In a block S300, the battery module 100 is charged by the external charger during its first use. Continuing to a decision block S302, the charging detection sub-module 1400 detects if the battery module 100 has been fully charged. If the battery module 100 has not been fully charged, the method continues to a block S300. If the battery module 100 has been fully charged, the method continues to a decision block S304. In the decision block S304, the charger detection sub-module 1410 detects if the external charger has been removed. If the external charger has not been removed, the charger detection sub-module 1410 continues to monitor the charger. If the external charger has just been removed, the method continues to a block S306. In block S306, the charging detection module 140 generates and sends a triggering signal to the central processing module 130. Moving to a block S308, the central processing module 130 receives the triggering signal and sets the offset calculating flag to the enable status.

Continuing to a block S310, when the voltage detection module 120 detects that the offset calculating flag has become the enable status, the voltage detection module 120 detects the initial voltage of the battery module 100 and sends the initial voltage to the central processing module 130. Moving to a block S312, the central processing module 130 receives the initial voltage, calculates the voltage offset according to the initial voltage and the voltage-capacitance relation, stores the voltage offset in the storage module 110, and sets the offset calculating flag to the disable status.

The wireless communication terminal 10 and the battery capacitance measuring method detects the voltage of the battery module 100 when the battery module 100 has been fully charged for the first time, as well as when the external charger has been removed. The wireless communication terminal 10 retrieves an actual voltage according to the voltage-capacitance relation to calculate the voltage offset. If the wireless communication terminal 10 detects voltage, the wireless communication terminal 10 calculates the actual voltage according to the voltage offset to retrieve the actual battery capacitance to avoid misleading users into excessively charging the battery.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A wireless communication terminal comprising:
a battery module configured for providing power to the wireless communication terminal and being charged by an external charger;
a storage module configured for storing a voltage offset and a voltage-capacitance relation between voltages and battery capacitance of the battery module;
a voltage detection module configured for detecting a voltage of the battery module; and
a central processing module configured for calculating an actual voltage of the battery module according to the detected voltage and the voltage offset, and obtaining an actual battery capacitance of the battery module according to the actual voltage and the voltage-capacitance relation.

2. The wireless communication terminal of claim 1, further comprising a display module configured for displaying the actual battery capacitance of the battery module.

3. The wireless communication terminal of claim 1, further comprising a charging detection module configured for detecting if the battery module has been fully charged and if the external charger has been removed, and for generating a triggering signal if detecting that the battery module has been fully charged for the first time and the external charger has been removed.

4. The wireless communication terminal of claim 3, wherein the voltage detection module comprises an offset calculating flag configured for indicating an enable status and a disable status, wherein the enable status represents that the battery module has been fully charged for the first time and the external charger has been removed, and that the voltage offset of the battery module is calculated; and the disable status represents that the voltage offset of the battery module has been calculated.

5. The wireless communication terminal of claim 4, wherein the central processing module is further configured for setting the offset calculating flag to the enable status according to the triggering signal.

6. The wireless communication terminal of claim 5, wherein the voltage detection module is further configured for detecting an initial voltage of the battery module when detecting that the offset calculating flag has become the enable status.

7. The wireless communication terminal of claim 6, wherein the central processing module is further configured for calculating the voltage offset of the battery module according to the voltage-capacitance relation and the initial voltage, storing the voltage offset in the storage module, and setting the offset calculating flag to the disable status.

8. The wireless communication terminal of claim 3, wherein the charging detection module comprises a charging detection sub-module configured for detecting whether the battery module has been fully charged, and a charger detection sub-module configured for detecting whether the external charger has been removed.

9. A battery capacitance measuring method for utilization in a wireless communication terminal comprising a battery module, a central processing module, and a storage module, the battery capacitance measuring method comprising:
detecting a voltage of the battery module, and sending the detected voltage to the central processing module;
calculating an actual voltage of the battery module according to the detected voltage and a voltage offset stored in the storage module; and
obtaining actual battery capacitance of the battery module based on the actual voltage and a voltage-capacitance relation between voltages and battery capacitance of the battery module stored in the storage module.

10. The battery capacitance measuring method of claim 9, further comprising:
sending the actual battery capacitance to a display module of the wireless communication terminal; and
displaying the actual battery capacitance.

11. The battery capacitance measuring method of claim 9, further comprising:
charging the battery module by an external charger during its first use;
detecting if the battery module has been fully charged;
detecting if the external charger has been removed if the battery module has been fully charged;
generating a triggering signal if the external charger has just been removed;
setting an offset calculating flag to an enable status according to the triggering signal;
detecting an initial voltage of the battery module when detecting that the offset calculating flag has become the enable status; and
calculating the voltage offset of the battery module according to the initial voltage and the voltage-capacitance relation, and setting the offset calculating flag to a disable status.

12. The battery capacitance measuring method of claim 11, further comprising:
storing the voltage offset in the storage module.

13. The battery capacitance measuring method of claim 11, wherein the enable status represents that the battery module has been fully charged for the first time and the external charger has been removed, and the voltage offset of the battery module is calculated; and the disable status represents that the voltage offset of the battery module has been calculated.
